(19) United States
(12) Patent Application Publication
(10) Pub. No.: US 2026/0221868 A1
(43) Pub. Date: Jul. 30, 2026

(54) DUTY-CYCLE-BASED EXTENDED CURRENT LIMIT

(71) Applicant: QUALCOMM Incorporated, San Diego, CA (US)

(72) Inventors: Jialei XU, Santa Clara, CA (US); Joseph Dale RUTKOWSKI, Chandler, AZ (US); Hector CORLETO, Chandler, AZ (US); Ji Hoon HYUN, San Jose, CA (US); Qian YAO, Cupertino, CA (US)

(21) Appl. No.: 19/461,045

(22) Filed: Jan. 27, 2026

Related U.S. Application Data
(60) Provisional application No. 63/750,875, filed on Jan. 29, 2025.

(51) Int. Cl. H02M 1/32; H02M 1/00; H02M 3/156

(52) U.S. Cl. CPC H02M 1/32; H02M 1/0009; H02M 3/156

(57) ABSTRACT

Certain aspects of the present disclosure are directed towards a power supply control circuit. The power supply control circuit generally includes: a duty cycle measurement circuit configured to identify a duty cycle associated with entering and exiting an over-current condition; and a multiplexer circuit coupled to the duty cycle measurement circuit and configured to set a current limit for a current associated with a power supply circuit to a first threshold or a second threshold based on the duty cycle, the second threshold being less than the first threshold.

### CROSS-REFERENCE TO RELATED APPLICATION

This application claims benefit of and priority to U.S. Provisional Application No. 63/750,875 filed Jan. 29, 2025, which is hereby expressly incorporated by reference herein in its entirety as if fully set forth below and for all applicable purposes.

### TECHNICAL FIELD

Certain aspects of the present disclosure generally relate to power supply circuits and, more particularly, to techniques and apparatus for supplying power to a load.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A switching regulator (also known as a “switching converter” or “switcher”) may be implemented, for example, by a switched-mode power supply (SMPS), such as a buck converter, a boost converter, a buck-boost converter, or a charge pump.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc. A charger used for battery charging may include a regulator for generating a system voltage (Vsys) at an output coupled to a load.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a power supply control circuit. The power supply control circuit generally includes: a duty cycle measurement circuit configured to identify a duty cycle associated with entering and exiting an over-current condition; and a multiplexer circuit coupled to the duty cycle measurement circuit and configured to set a current limit for a current associated with a power supply circuit to a first threshold or a second threshold based on the duty cycle, the second threshold being less than the first threshold.

Certain aspects of the present disclosure are directed towards a method for power supply control. The method generally includes: identifying, via a duty cycle measurement circuit, a duty cycle associated with entering and exiting an over-current condition; and setting, via a multiplexer circuit, a current limit for a current associated with a power supply circuit to a first threshold or a second threshold based on the duty cycle, the second threshold being less than the first threshold.

Certain aspects of the present disclosure are directed towards a charger. The charger generally includes: a power supply circuit; a duty cycle measurement circuit configured to identify a duty cycle associated with entering and exiting an over-current condition; and a multiplexer circuit coupled to the duty cycle measurement circuit and configured to set a current limit for a current associated with the power supply circuit to a first threshold or a second threshold based on the duty cycle, the second threshold being less than the first threshold.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a power management integrated circuit (PMIC) and a battery charging circuit, in which aspects of the present disclosure may be practiced.

FIG. 2 illustrates a power supply circuit with a charger used to charge a battery, in accordance with certain aspects of the present disclosure.

FIG. 3 is a timing diagram showing states of components and signals of the power supply circuit of FIG. 2 operated with voltage tracking, in accordance with certain aspects of the present disclosure.

FIG. 4 is a timing diagram showing states of components and signals of the power supply circuit of FIG. 2 operated with fixed voltage regulation, in accordance with certain aspects of the present disclosure.

FIG. 5 is a timing diagram showing states of components and signals of the power supply circuit of FIG. 2 operated with an extended current limit, in accordance with certain aspects of the present disclosure.

FIG. 6 is a timing diagram showing states of components and signals of the power supply circuit of FIG. 2 operated with an extended current limit, in accordance with certain aspects of the present disclosure.

FIG. 7 is a circuit diagram for implementing an extended current limit, in accordance with certain aspects of the present disclosure.

FIG. 8 is a block diagram of circuitry for generating a cooldown signal, in accordance with certain aspects of the present disclosure.

FIG. 9 is a block diagram illustrating an example implementation of a moving average filter, in accordance with certain aspects of the present disclosure.

FIG. 10 is a diagram illustrating various duty cycles associated with various time windows, in accordance with certain aspects of the present disclosure.

FIG. 11 is a flow diagram illustrating example operations for power supply control, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards apparatus and techniques for controlling a power supply circuit. For example, the techniques described herein may extend a current limit for a regulator (e.g., direct current (DC) to DC (DC/DC) converter) using a duty-cycle-based approach that sets a higher input (or output) current limit (e.g., compared to an input current limit (ICL) typically used by the regulator) by employing a duty cycle counter to identify a duty cycle associated with entering and exiting an over-current condition within an evaluation window (e.g., a time window). In some cases, an average of duty cycles within multiple evaluation windows may be identified. If the average duty cycle surpasses a threshold, a lower current limit (e.g., the ICL or any suitable cooldown threshold) may be used for a cooldown period, thereby allowing for higher peak power delivery with little to no compromise of thermal performance, improving power delivery efficiency in the presence of dynamic loads.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

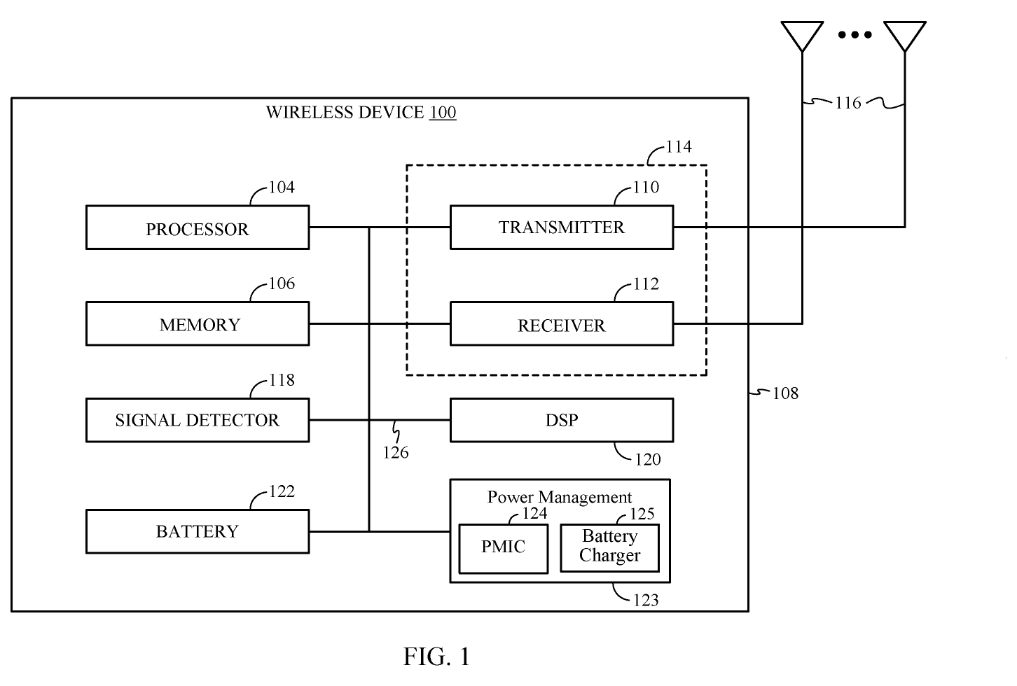

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

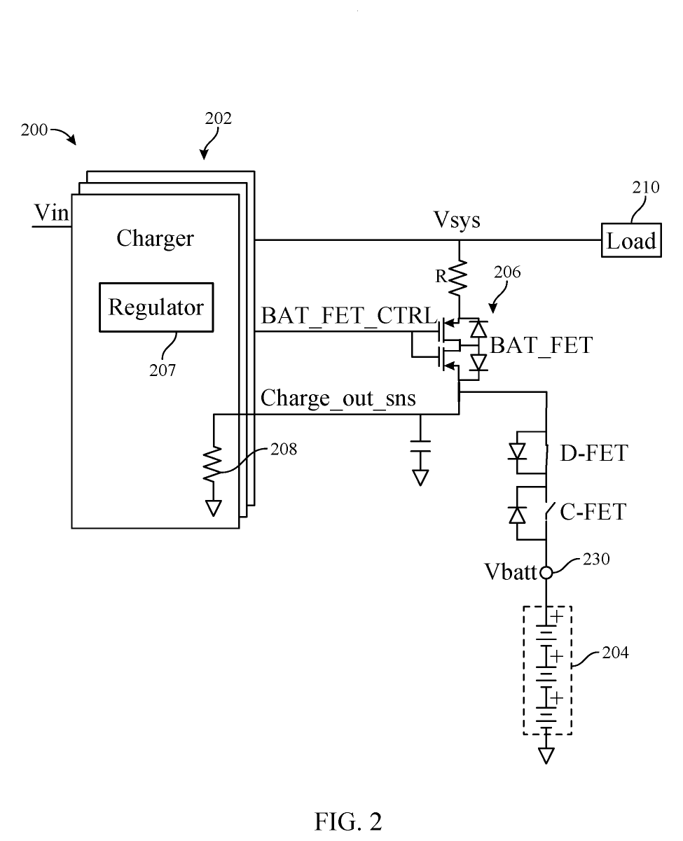

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2). In some aspects, the PMIC may be implemented with a ripple voltage reduction circuit as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Power Supply Introduction

Certain aspects of the present disclosure are directed towards a power supply circuit, including a battery charger. The charger may generate a system voltage (Vsys) that may be regulated to a voltage (e.g., also referred to as a tracking voltage) above a battery voltage (Vbatt) or regulated to a fixed voltage (e.g., referred to herein as a floating voltage (Vfloat)) based on Vbatt. In some chargers, a charging field-effect transistor (C-FET) between a voltage sense node (also referred to herein as a charging output sense node) of the charger and the battery may be turned off after charging is terminated to cut off the charging path to the battery. As a result, the battery output voltage node may be unable to sink current from the voltage sense node, causing a floating or high-impedance condition at the voltage sense node. If the power draw from the load coupled to the charger exceeds an input power (current) limit of the charger, the charger may enter an input current limit (ICL) condition or a battery supplement mode (BSM), and Vsys may drop to a diode voltage (Vdiode) below Vbatt. Upon exiting the ICL condition or BSM, a voltage spike or a ripple (e.g., 600 mV ripple) may occur. When the amount of power being drawn by the load is close to the input power limit, the power supply circuit may enter and exit the ICL condition or BSM, causing a series of ripples that may cause audible noise. Certain aspects of the present disclosure are directed towards techniques for reducing the ripple voltage to reduce the audible noise, as described in more detail herein.

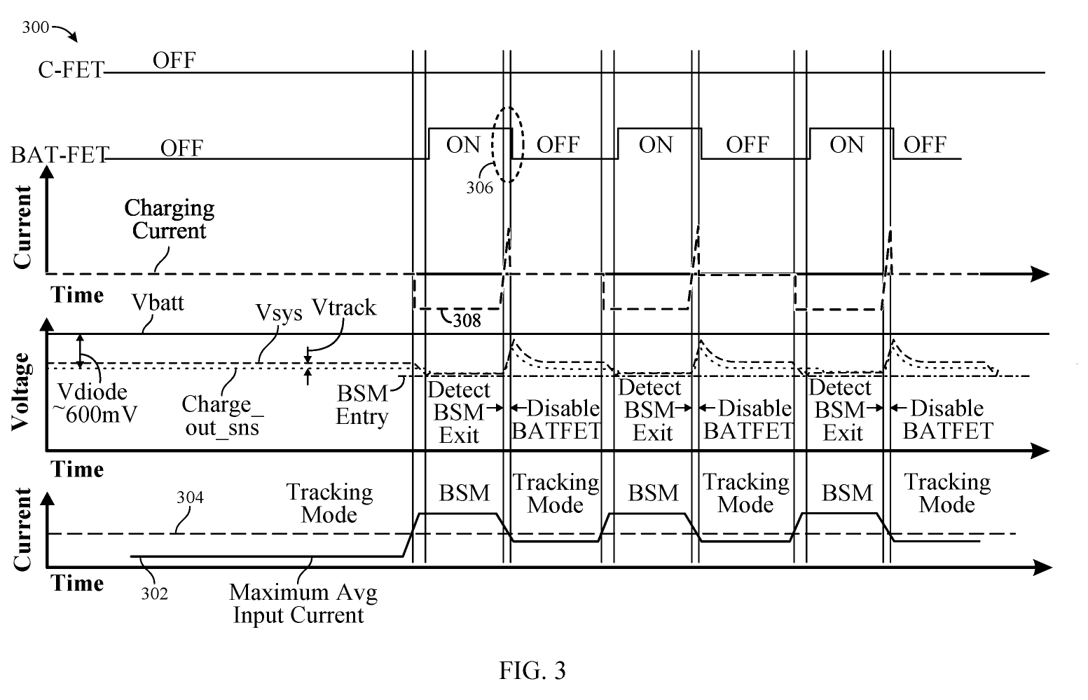

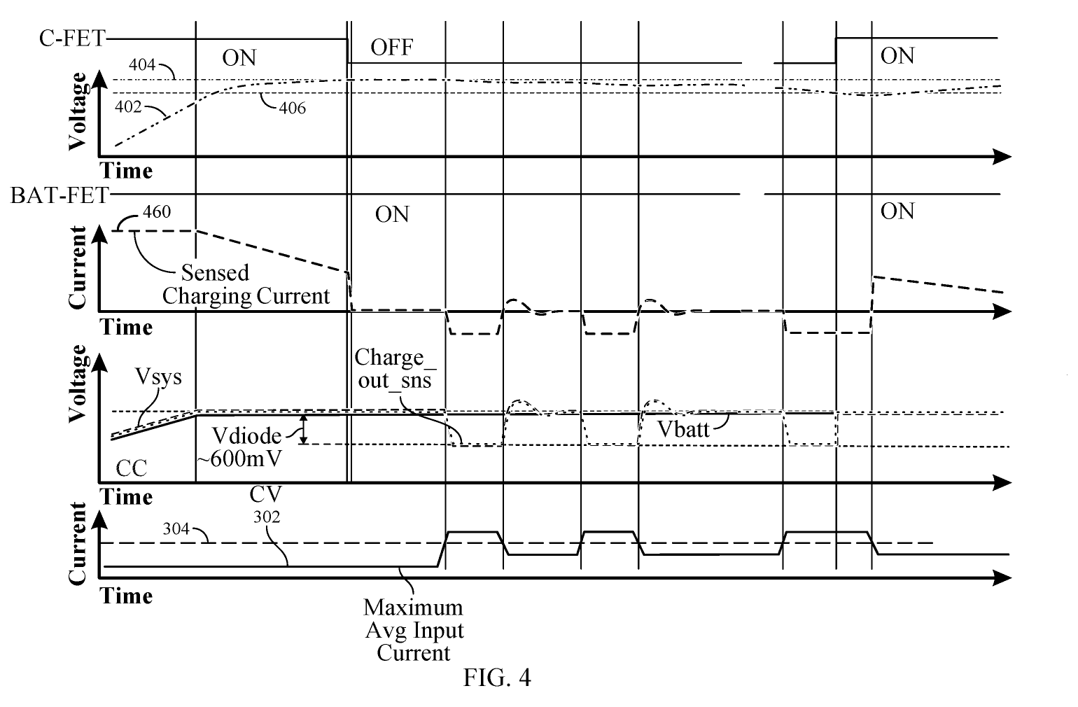

FIG. 2 illustrates a power supply circuit 200 including a charger 202 used to charge a battery 204 (e.g., a battery stack). The charger 202 may receive an input voltage (Vin) and generate, via a regulator 207, Vsys at an output node (e.g., Vsys node) coupled to a load 210. The charger 202 may regulate Vsys to a voltage (e.g., referred to as a tracking voltage (Vtrack)) above a sensed battery voltage (Vbatt) as described in more detail with respect to FIG. 3 or may generate a fixed voltage (Vfloat) based on the sensed Vbatt as described in more detail with respect to FIG. 4.

The battery voltage (Vbatt) may be sensed at a charging output sense (labeled “charge_out_sns”) node. A battery FET 206 (BAT_FET) may be coupled between the Vsys node and the charge_out_sns node, as shown. A resistive element R may be coupled between the Vsys node and the FET 206. As shown, the FET 206 may be implemented using back-to-back FETs (FETs in series with body diodes pointing in opposite directions) to allow bidirectional current flow for battery charging and supplementing power to the load 210 via the battery 204. The charger 202 may control the FET 206 via a battery FET control (BAT_FET_CTRL) signal, as shown. The charge_out_sns node may be coupled to a battery port 230 (e.g., coupled to the battery 204) through a discharge FET (labeled “D-FET”) and a charge FET (labeled “C-FET”). The charge_out_sns node may be coupled to a reference potential node (e.g., electric ground) through a resistive element 208 of the charger 202.

FIG. 3 is a timing diagram 300 showing states of components and signals of the power supply circuit 200 operated with voltage tracking, in accordance with certain aspects of the present disclosure. As shown in timing diagram 300, during a tracking mode of operation, Vsys may be regulated to track a particular voltage (e.g., the charge_out_sns voltage), following this voltage at (or within) a predefined voltage difference (Vtrack). For example, Vsys may be greater than (e.g., by 50 mV) but track the charge_out_sns voltage. Vbatt may be greater than the charge_out_sns voltage by Vdiode, which may be 600 mV, for example.

The C-FET (e.g., C-FET switch) may be turned off (e.g., opened) after the charging of the battery has been terminated to cut off the charging path to the battery 204. The charging current may be zero when the C-FET is turned off. Thus, current may not sink to the battery from the charge_out_sns node, causing the charge_out_sns node to be a high-impedance node (e.g., also referred to herein as a floating charge_out_sns node or a high-impedance charge_out_sns node).

As described, the load 210 may consume power, causing an ICL condition for the charger. For example, curve 302 may represent the maximum of the average input current of the charger 202. Once the maximum of the average input current exceeds an ICL 304, the charger may enter the ICL condition. In some cases, after or in response to entering the ICL condition, the power supply circuit 200 may enter a battery supplement mode (BSM) where the battery begins to supplement the power to the load. As shown, the charging current 308 (e.g., corresponding to a current across FET 206) may be negative due to the current flowing to the load from the battery. The negative charging current may be, in effect, a battery discharge current referred to herein as “IBAT_DISCHG.” Vsys and the charge_out_sns voltage may drop to Vdiode below Vbatt, as shown. Vdiode may be the forward voltage drop of a diode, such as the body diode of the C-FET, which may be 600 mV. In BSM, the BAT_FET (FET 206) turns on to facilitate the power delivery to the load from the battery.

Once the maximum of the average input current drops below the ICL 304, the charger may exit the ICL condition, and current may flow from the charger 202 (e.g., Vsys node) to the high-impedance charge_out_sns node, causing a voltage spike (e.g., a potentially greater than 600 mV voltage spike) at the Vsys node and the charge_out_sns node, as shown. This may be due to a delay from when the charger 202 exits the ICL condition (or BSM) and when the BAT_FET (FET 206) turns off at time 306, providing a path for current flow from the charger 202 to the high-impedance charge_out_sns node.

The power draw from the load may cause a boundary condition for the ICL. That is, the maximum of the average input current represented by curve 302 may transition back and forth above and below the ICL 304. Thus, the power supply circuit 200 may transition back and forth between BSM and tracking mode, causing ripples at a particular frequency. In some cases, this frequency may be within an audible frequency range, causing an audible noise to be emitted from the power supply circuit.

FIG. 4 is a timing diagram showing states of components and signals of the power supply circuit 200 operated with fixed voltage regulation, in accordance with certain aspects of the present disclosure. For example, Vsys may be regulated to a fixed voltage. As shown, when the battery cell voltage 402 reaches an end of charge threshold 404, charging may be terminated by turning off the C-FET, and when the voltage 402 reaches a charge threshold 406, charging may begin by turning on the C-FET. As shown, the BAT_FET (FET 206) may be on during both the charging and non-charging conditions.

During a constant current (CC) mode, the charging current may be constant. Thus, within CC mode, the charging current 460 is constant and Vsys, the charge_out_sns voltage, and Vbatt may increase. During a constant voltage (CV) mode, the charger 202 may regulate Vsys to be a fixed voltage (Vfloat), which is greater than Vbatt.

As shown, when the maximum of the average input current of the charger 202 increases above the ICL 304, Vsys drops to Vdiode below Vbatt. With the charge_out_sns node being a high-impedance node, when the ICL condition ends, Vsys and the charge_out_sns voltage increase above Vbatt, causing a ripple voltage. As described, the power drawn from the load 210 may cause a boundary condition for the input current limit, causing ripples at an audible frequency range and resulting in an audible noise from the power supply circuit.

### Example Techniques for Extended Current Limiting

Input current limit (ICL) may be used in a charger (e.g., charger integrated circuits (IC)) to limit the total power drawn from a power source, such as a wall adapter, dock, or hub, in an attempt to prevent triggering an output current limit of the power source, which may eventually result in an output voltage collapse. The total power consumption of the charger IC may also be limited to avoid high thermal conditions that could result in violating skin temperature (Tskin) specifications of the power source or resulting in reliability issues for the charger. When a downstream circuit load draws power that exceeds the ICL of the charger, the output voltage of the charger may collapse, resulting in a device brownout condition or a voltage ripple at a supply voltage rail (e.g., due to repetitive heavy load attacks as described herein with respect to FIGS. 3 and 4). In some cases, there may be some margin in the power capability of the power source (e.g., wall adapter, dock, or hub) compared to the ICL of the charger. In other words, the power source may be capable of supplying more current than what is allowed by the ICL of the charger.

Certain aspects of the present disclosure provide techniques for using the available power headroom (margin) of the power source (e.g., wall adapter, dock, or hub) to boost available supply power. For example, assume the power source is capable of providing 100 Watts (e.g., 20 Volts at 5 Amps) of power, but the charger IC thermal limit is set at 60 Watts. That is, the wall adapter may still have 40 Watts of available headroom in output power capability that is unused. The charger IC may not use this available headroom in an effort to avoid overheating, for example. Certain aspects of the present disclosure are directed toward techniques for using the available power for an electronic circuit load while avoiding thermal issues.

When the ICL is triggered, Vsys may drop below a battery voltage (Vbatt), creating a voltage ripple as described herein with respect to FIGS. 3 and 4. That is, repetitively heavy load attacks resulting in a current draw higher than the ICL may create voltage ripples at the converter output node (e.g., Vsys node of FIG. 2). When the load current exceeds the ICL of the converter, Vsys may drop below the charge_out_sns voltage level, creating a high Vsys voltage ripple when using a fixed ICL.

Certain aspects of the present disclosure are directed towards using an extended current limit (referred to herein as “I_peak” or “IPEAK”) that allows for using the available power headroom of a power source while also reducing the voltage ripple described herein. For example, an extended current limit may be introduced to allow for the charger IC to temporarily exceed the direct current (DC) limit of the charger. While some examples provided herein are described with respect to an ICL to facilitate understanding, certain aspects of the present disclosure may be applied to any current limit, such as an output current limit of a charger.

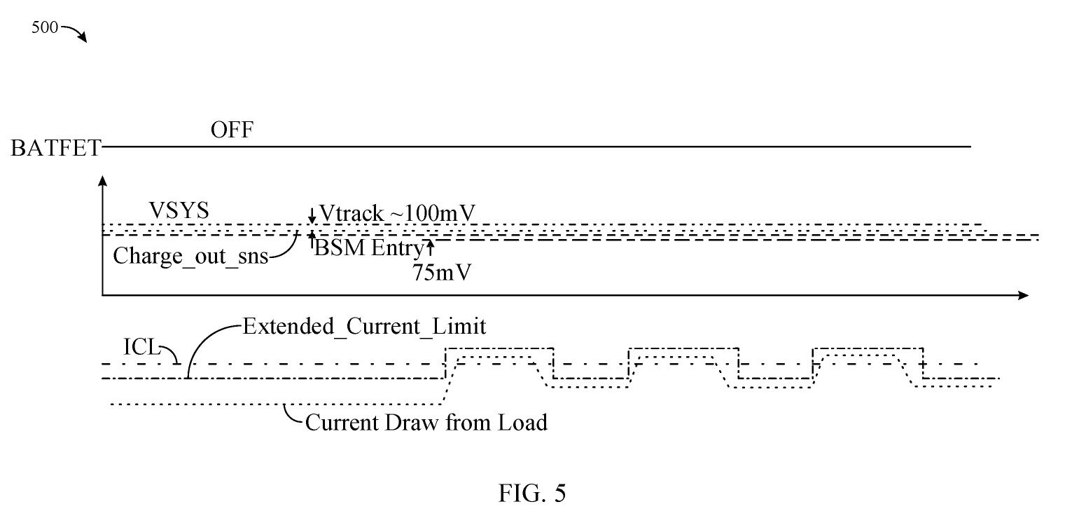

FIG. 5 is a timing diagram 500 showing states of components and signals of the power supply circuit 200 operated with an extended current limit, in accordance with certain aspects of the present disclosure. As shown, the extended current limit (labeled “Extended_Current_Limit”) may exceed the ICL when the load current increases above a threshold. In this manner, by using the extended current limit to enter a current limit condition as opposed to the ICL, the power supply circuit 200 is able to avoid (at least temporarily) the current limit condition. As shown, by avoiding entering the current limit condition, the voltage ripple of Vsys described herein may be avoided.

In some aspects, a duty cycle associated with entering and exiting an over-current condition may be identified, where the over-current condition occurs when an input current (IIN) of the charger exceeds a DC limit. If the duty cycle associated with entering and exiting the over-current conditions exceeds a predefined duty cycle threshold, a lower ICL may be enforced (e.g., the ICL may be prevented from being raised to the extended current limit (higher ICL)) for a cooldown period until the duty cycle is below the duty cycle limit. In this manner, the extra power headroom of the power source may be used to supply peak power to a load while mitigating thermal issues.

In some aspects, to further push the power capability of the charger, an extended current limit (IPEAK) may be introduced. IPEAK may be set at a threshold that is higher than the ICL specified due to thermal or other specifications. IPEAK may be set as a default current limit and used until a duty cycle associated with entering and exiting an over-current condition exceeds some duty cycle threshold.

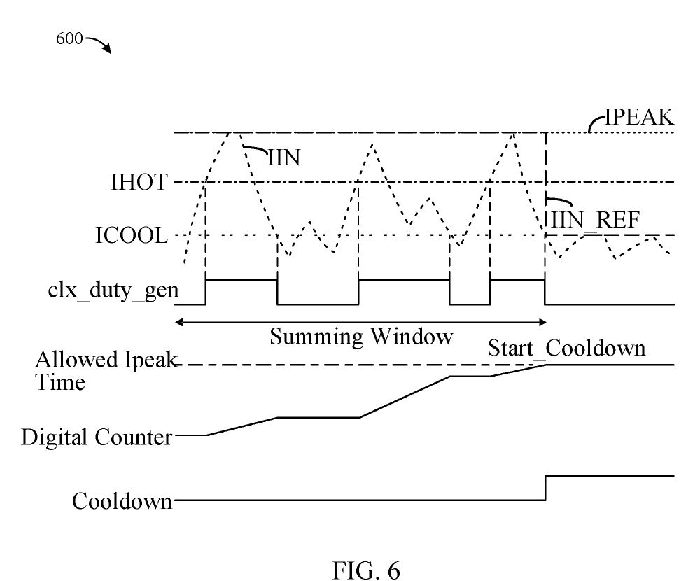

FIG. 6 is a timing diagram 600 showing states of components and signals of the power supply circuit 200 operated with IPEAK, in accordance with certain aspects of the present disclosure. As shown, the current limit may be held at IPEAK. A duty cycle counter may be used to track the over-current conditions’ duty cycle within a fixed evaluation time window. An over-current condition occurs when the IIN of the charger transitions above a current threshold labeled “IHOT” and ends when the IIN drops below a current threshold labeled “ICOOL.” A signal labeled “clx_duty_gen” represents the occurrences of the over-current conditions. The clx_duty_gen signal transitions to logic high (1) when IIN is greater than IHOT and transitions to logic low (0) when IIN is less than ICOOL.

Suppose the average of the duty cycles associated with the over-current conditions during a time window (e.g., referred to as a “summing window”) exceeds a preset duty cycle threshold. In that case, ICOOL may be used for a cooldown period to maintain the average duty cycle below a threshold that avoids overheating. By using IPEAK, a DC-to-DC converter (e.g., regulator 207 of FIG. 2) of the charger may be able to deliver more instantaneous power without compromising the device’s thermal performance.

A digital counter may be used to keep track of the duty cycle of the clx_duty_gen signal within a time window, such as the time window labeled “summing window” in FIG. 6. The current limit of the converter may be set using a reference input current (IIN_REF) signal. If the duty cycle exceeds a duty cycle threshold, the IIN_REF signal may be dropped from IPEAK to ICOOL during a cooldown period. As shown, the IIN of the charger may not exceed IIN_REF. For instance, the digital counter may generate a counter signal that represents the duty cycle of the clx_duty_gen signal with a time window. If the counter signal reaches some threshold (e.g., representing an allowed peak current (IPEAK) time), the cooldown period may be initiated.

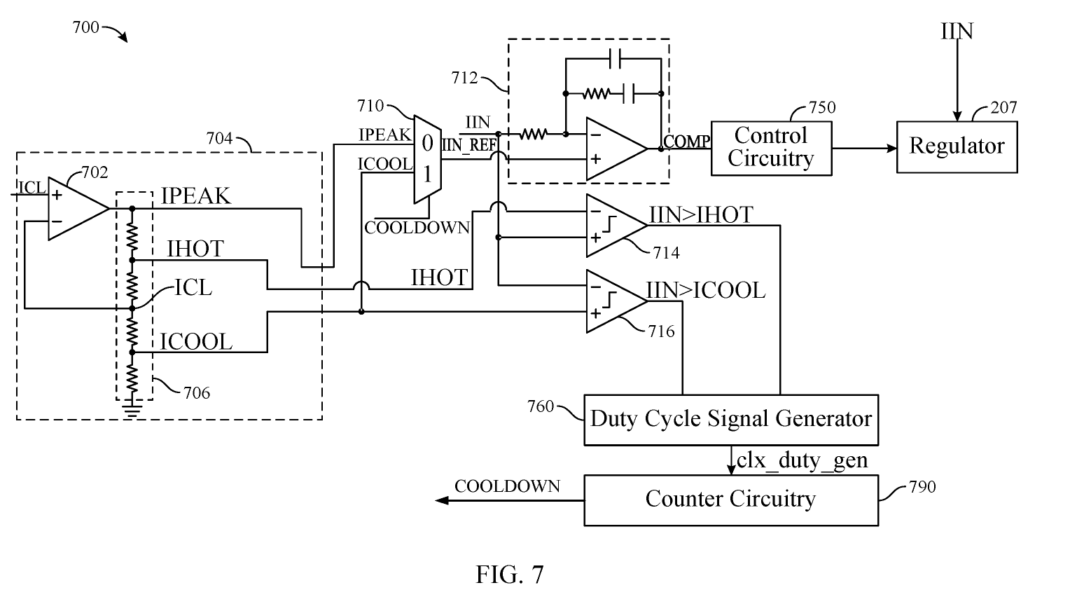

FIG. 7 is a block diagram of a current limit extension circuit 700 for implementing an extended current limit, in accordance with certain aspects of the present disclosure. As shown, the circuit 700 may include a signal generator 704 that may be used to generate IPEAK, ICOOL, and IHOT signals based on the ICL. For example, the signal generator 704 may include an amplifier 702 receiving, at a positive input terminal, a signal representing the ICL, where a negative input of the amplifier 702 is coupled to a tap of a voltage divider 706. The different taps of the voltage divider 706 may provide IPEAK, IHOT, and ICOOL. The circuit 700 may also include a multiplexer 710 that may receive, as inputs, the IPEAK and ICOOL signals. The IIN_REF signal may be set to IPEAK or ICOOL, depending on whether the charger is within a cooldown condition. For example, based on a cooldown signal, the multiplexer 710 may provide, as the IIN_REF signal, either IPEAK or ICOOL.

The circuit 700 may also include a comparator 714 that compares IIN with IHOT and a comparator 716 that compares IIN with ICOOL. The output signal of comparator 714 may indicate whether IIN is greater than IHOT, and the output signal of comparator 716 may indicate whether IIN is greater than ICOOL. The output signals of comparators 714, 716 may be provided to a duty cycle signal generator 760 to generate the clx_duty_gen signal for duty cycle tracking. That is, as described herein, the clx_duty_gen signal transitions to logic high (1) when the input current (IIN) is greater than IHOT and transitions to logic low (0) when IIN is less than ICOOL. In some cases, the clx_duty_gen signal may be provided to counter circuitry 790 to generate a counter signal representing a duty cycle associated with entering and exiting an over-current condition within a time window. If the counter signal reaches some threshold (e.g., representing an allowed peak time as shown in FIG. 6), a cooldown period may begin by controlling the multiplexer 710 as described.

As shown, the current limit extension circuit 700 may also include an error amplifier 712 configured to compare the IIN of the charger with IIN_REF (e.g., IPEAK or ICOOL) to generate a comparison (COMP) signal. The COMP signal may be provided to control circuitry 750 for the regulator 207. Based on the COMP signal, the control circuitry 750 controls the regulator 207 such that IIN does not exceed IIN_REF, as described with respect to FIG. 6.

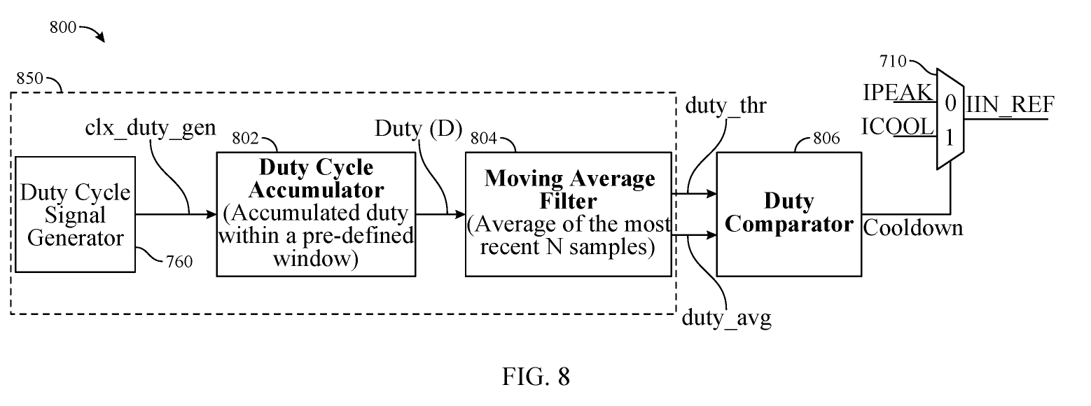

FIG. 8 is a block diagram of a cooldown signal generator circuit 800, in accordance with certain aspects of the present disclosure. The circuit 800 may include a duty cycle measurement circuit 850 and a duty comparator 806. The duty cycle measurement circuit 850 may include the duty cycle signal generator 760 described with respect to FIG. 7 and a duty cycle accumulator 802 that may receive the clx_duty_gen signal to generate a duty cycle (labeled “Duty (D)”) signal indicating the duty cycle associated with an over-current condition within each of multiple predefined time windows. The circuit 850 may also include a moving average filter 804 that may receive the duty cycle signal from the accumulator 802 and generate an average duty cycle (duty_avg) signal indicating the average duty cycle across N recent samples of the duty cycle signal, N being a positive integer. The duty comparator 806 may compare the average duty cycle signal with a duty cycle threshold (duty_thr) to generate the cooldown signal. The cooldown signal may be provided to the multiplexer 710 to control whether IPEAK or ICOOL is to be used as the IIN_REF signal, as described with respect to FIG. 7.

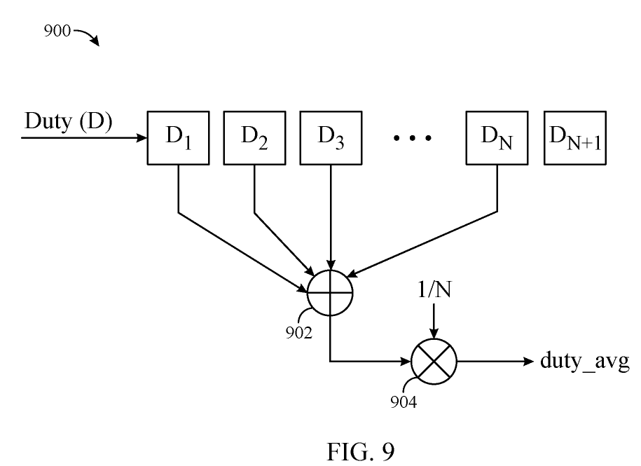

FIG. 9 is a block diagram 900 illustrating an example implementation of the moving average filter 804, in accordance with certain aspects of the present disclosure. The moving average filter 804 may receive duty cycles of over-current conditions within the previous N time windows (e.g., N being a positive integer), labeled as duty cycles D₁ to D_{N}. The duty cycles may be provided to a summing circuit 902 to generate a duty cycle sum that is then multiplied by 1/N (e.g., divided by N) via a multiplier circuit 904, to generate the average duty cycle signal.

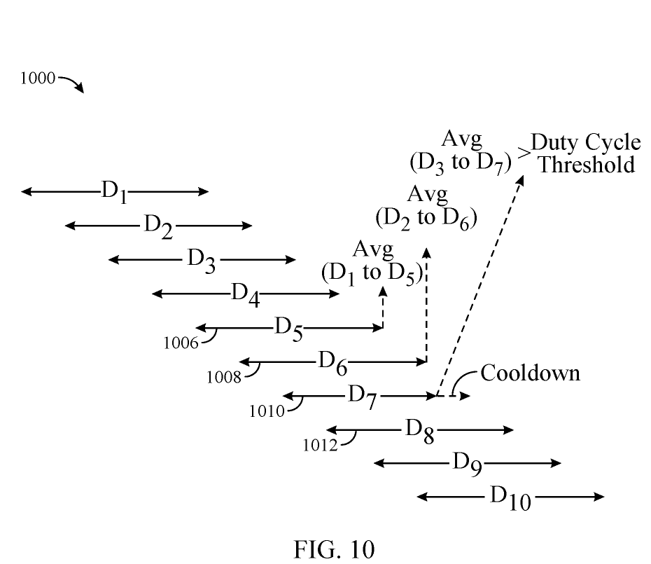

FIG. 10 is a diagram 1000 illustrating various duty cycles associated with various time windows, in accordance with certain aspects of the present disclosure. As shown, a duty cycle may be generated (e.g., via the duty cycle accumulator 802) for each of multiple time windows labeled D₁ to D₁₀. An average duty cycle may be generated for previous N time windows. For example, at the end of time window 1006, the average of duty cycles D₁ to D₅ may be calculated, at the end of time window 1008, the average of duty cycles D₂ to D₆ may be calculated, at the end of time window 1010, the average of duty cycles D₃ to D₇ may be calculated, and so on. Assume the average of duty cycles D₃ to D₇ exceeds a duty cycle threshold (e.g., duty_thr described with respect to FIG. 8). As a result, a cooldown period may begin. In some cases, the cooldown period may last until the end of a current time window, such as the end of time window 1012, or may the cooldown period may end before the end of the current time window as shown.

The techniques described herein effectively extend the current limit for systems with bursty load profiles, providing increased peak system power with a slight area increase (e.g., additional comparator, buffer, and counter) in a system with dynamic power consumption, such as a computer or a cell phone. Some aspects use a higher current limit (e.g., IPEAK) as the default, avoiding any delays for a control loop to transition between a current limit and an extended current limit. When properly programmed, the techniques described herein can effectively avoid current limit events when the clx_duty_gen signal is lower than the predefined duty cycle threshold.

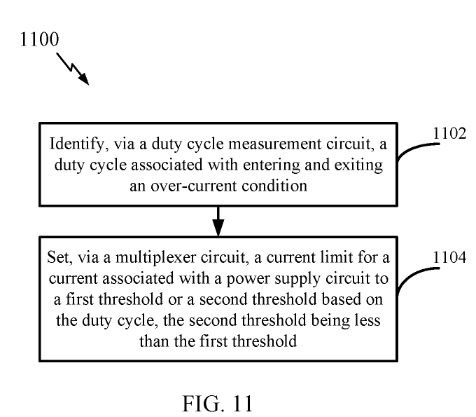

FIG. 11 is a flow diagram illustrating example operations 1100 for power supply control, in accordance with certain aspects of the present disclosure. The operations 1100 may be performed, for example, by a power supply control circuit, such as the current limit extension circuit 700 of FIG. 7 and the cooldown signal generator circuit 800 of FIG. 8.

At block 1102, the power supply control circuit may identify, via a duty cycle measurement circuit (e.g., duty cycle measurement circuit 850 of FIG. 8), a duty cycle associated with entering and exiting an over-current condition.

At block 1104, the power supply control circuit sets, via a multiplexer circuit (e.g., multiplexer 710 of FIGS. 7 or 8), a current limit (e.g., represented by IIN_REF) for a current (e.g., IIN) associated with a power supply circuit (e.g., regulator 207) to a first threshold (e.g., IPEAK) or a second threshold (e.g., ICOOL) based on the duty cycle, the second threshold being less than the first threshold. Identifying the duty cycle may include identifying the duty cycle of a signal representing an occurrence of the over-current condition.

In some aspects, the first threshold is a peak current threshold, and the second threshold is a cooldown threshold. The multiplexer circuit may be configured to change the current limit from the peak current threshold to the cooldown threshold (e.g., to reduce a temperature of the power supply circuit).

In some aspects, the power supply control circuit compares, via a comparison circuit (e.g., error amplifier 712 of FIG. 7), a current (e.g., IIN shown in FIG. 7) associated with the power supply circuit with the first threshold or the second threshold. The power supply control circuit may control, via control circuitry (e.g., control circuitry 750), the power supply circuit such that the current associated with the power supply circuit does not exceed the current limit based on the comparison.

In some aspects, the over-current condition begins when the current (e.g., IIN) associated with the power supply circuit exceeds a third threshold (e.g., IHOT) and ends when the input or output current decreases below a fourth threshold (e.g., ICOOL). In some aspects, the fourth threshold is the same as the second threshold. The current associated with the power supply circuit may include an input current or an output current of the power supply circuit. The fourth threshold (e.g., ICOOL) is less than the third threshold (e.g., IHOT).

In some aspects, identifying the duty cycle may include identifying the duty cycle within a configured time window. For example, the power supply control circuit may generate, via a counter, a counter signal indicating an amount of time within a configured time window that the power supply circuit is in the over-current condition, the current limit being set to the second threshold based on the counter signal reaching a threshold (e.g., a threshold count or a threshold time) within the configured time window. The amount of time may indicate an average of the duty cycle within the configured time window.

For example, identifying the duty cycle associated with entering and exiting the over-current condition may include identifying duty cycles associated with entering and exiting the over-current condition within each of multiple time windows, the current limit being set based on the duty cycles. Identifying the duty cycle associated with entering and exiting the over-current condition may include identifying an average duty cycle across the multiple time windows, the current limit being set based on the average duty cycle. Setting the current limit may include: setting the current limit to the first threshold; and adjusting the current limit from the first threshold to the second threshold based on the average duty cycle meeting a duty cycle threshold. In some aspects, the first threshold is greater than an input current limit for the power supply circuit, and the second threshold is less than the input current limit.

### Example Aspects

In addition to the various aspects described above, specific combinations of aspects are within the scope of the disclosure, some of which are detailed below:

Aspect 1: A power supply control circuit comprising: a duty cycle measurement circuit configured to identify a duty cycle associated with entering and exiting an over-current condition; and a multiplexer circuit coupled to the duty cycle measurement circuit and configured to set a current limit for a current associated with a power supply circuit to a first threshold or a second threshold based on the duty cycle, the second threshold being less than the first threshold.

Aspect 2: The power supply control circuit of Aspect 1, wherein, to identify the duty cycle, the duty cycle measurement circuit is configured to identify the duty cycle of a signal representing an occurrence of the over-current condition.

Aspect 3: The power supply control circuit of Aspect 1 or 2, wherein: the first threshold comprises a peak current threshold; and the second threshold comprises a cooldown threshold, the multiplexer circuit being configured to change the current limit for the current associated with the power supply circuit from the peak current threshold to the cooldown threshold.

Aspect 4: The power supply control circuit according to any of Aspects 1–3, further comprising: a comparison circuit configured to compare a current associated with the power supply circuit with the first threshold or the second threshold; and control circuitry configured to control the power supply circuit such that the current associated with the power supply circuit does not exceed the current limit based on the comparison.

Aspect 5: The power supply control circuit according to any of Aspects 1–4, wherein the over-current condition is configured to begin when the current associated with the power supply circuit exceeds a third threshold and to end when the current decreases below a fourth threshold.

Aspect 6: The power supply control circuit of Aspect 5, wherein the current associated with the power supply circuit comprises an input current or an output current of the power supply circuit.

Aspect 7: The power supply control circuit of Aspect 5 or 6, wherein the fourth threshold is less than the third threshold.

Aspect 8: The power supply control circuit according to any of Aspects 5–7, wherein the fourth threshold is the same as the second threshold.

Aspect 9: The power supply control circuit according to any of Aspects 1–8, wherein: the duty cycle measurement circuit comprises a counter configured to generate a counter signal indicating an amount of time within a configured time window that the power supply circuit is in the over-current condition; and the multiplexer circuit is configured to set the current limit to the second threshold based on the counter signal reaching a threshold within the configured time window.

Aspect 10: The power supply control circuit of Aspect 9, wherein the amount of time indicates an average of the duty cycle within the configured time window.

Aspect 11: The power supply control circuit according to any of Aspects 1–10, wherein, to identify the duty cycle associated with entering and exiting the over-current condition, the duty cycle measurement circuit is configured to identify duty cycles associated with entering and exiting the over-current condition within each of multiple time windows, the multiplexer circuit being configured to set the current limit based on the duty cycles.

Aspect 12: The power supply control circuit of Aspect 11, wherein, to identify the duty cycle associated with entering and exiting the over-current condition, the duty cycle measurement circuit is configured to identify an average duty cycle across the multiple time windows, the multiplexer circuit being configured to set the current limit based on the average duty cycle.

Aspect 13: The power supply control circuit of Aspect 12, wherein the multiplexer circuit is configured to: set the current limit to the first threshold; and adjust the current limit from the first threshold to the second threshold based on the average duty cycle meeting a duty cycle threshold.

Aspect 14: The power supply control circuit according to any of Aspects 1–13, further comprising a voltage divider circuit configured to generate signals representing the first threshold and the second threshold based on an input current limit (ICL) signal for the power supply circuit.

Aspect 15: The power supply control circuit according to any of Aspects 1–14, wherein the first threshold is greater than an input current limit (ICL) for the power supply circuit, and wherein the second threshold is less than the ICL.

Aspect 16: A method for power supply control, comprising: identifying, via a duty cycle measurement circuit, a duty cycle associated with entering and exiting an over-current condition; and setting, via a multiplexer circuit, a current limit for a current associated with a power supply circuit to a first threshold or a second threshold based on the duty cycle, the second threshold being less than the first threshold.

Aspect 17: The method of Aspect 16, wherein identifying the duty cycle includes identifying the duty cycle of a signal representing an occurrence of the over-current condition.

Aspect 18: The method of Aspect 16 or 17, wherein: the first threshold comprises a peak current threshold; the second threshold comprises a cooldown threshold; and setting the current limit comprises changing the current limit for the current associated with the power supply circuit from the peak current threshold to the cooldown threshold.

Aspect 19: The method according to any of Aspects 16–18, further comprising: comparing, via a comparison circuit, a current associated with the power supply circuit with the first threshold or the second threshold; and controlling, via control circuitry, the power supply circuit such that the current associated with the power supply circuit does not exceed the current limit based on the comparison.

Aspect 20: The method according to any of Aspects 16–19, wherein the over-current condition begins when the current associated with the power supply circuit exceeds a third threshold and ends when the current decreases below a fourth threshold.

Aspect 21: The method of Aspect 20, wherein the current associated with the power supply circuit comprises an input current or an output current of the power supply circuit.

Aspect 22: The method of Aspect 20 or 21, wherein the fourth threshold is less than the third threshold.

Aspect 23: The method according to any of Aspects 20–22, wherein the fourth threshold is the same as the second threshold.

Aspect 24: The method according to any of Aspects 16–23, further comprising generating, via a counter, a counter signal indicating an amount of time within a configured time window that the power supply circuit is in the over-current condition, the current limit being set to the second threshold based on the counter signal reaching a threshold within the configured time window.

Aspect 25: The method of Aspect 24, wherein the amount of time indicates an average of the duty cycle within the configured time window.

Aspect 26: The method according to any of Aspects 16–25, wherein identifying the duty cycle associated with entering and exiting the over-current condition includes identifying duty cycles associated with entering and exiting the over-current condition within each of multiple time windows, the current limit being set based on the duty cycles.

Aspect 27: The method of Aspect 26, wherein identifying the duty cycle associated with entering and exiting the over-current condition includes identifying an average duty cycle across the multiple time windows, the current limit being set based on the average duty cycle.

Aspect 28: The method of Aspect 27, wherein setting the current limit comprises: setting the current limit to the first threshold; and adjusting the current limit from the first threshold to the second threshold based on the average duty cycle meeting a duty cycle threshold.

Aspect 29: The method according to any of Aspects 16–28, wherein the first threshold is greater than an input current limit for the power supply circuit, and wherein the second threshold is less than the input current limit.

Aspect 30: A charger comprising: a power supply circuit; a duty cycle measurement circuit configured to identify a duty cycle associated with entering and exiting an over-current condition; and a multiplexer circuit coupled to the duty cycle measurement circuit and configured to set a current limit for a current associated with the power supply circuit to a first threshold or a second threshold based on the duty cycle, the second threshold being less than the first threshold.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply control circuit comprising:
a duty cycle measurement circuit configured to identify a duty cycle associated with entering and exiting an over-current condition; and
a multiplexer circuit coupled to the duty cycle measurement circuit and configured to set a current limit for a current associated with a power supply circuit to a first threshold or a second threshold based on the duty cycle, the second threshold being less than the first threshold.

2. The power supply control circuit of claim 1, wherein, to identify the duty cycle, the duty cycle measurement circuit is configured to identify the duty cycle of a signal representing an occurrence of the over-current condition.

3. The power supply control circuit of claim 1, wherein:
the first threshold comprises a peak current threshold; and
the second threshold comprises a cooldown threshold, the multiplexer circuit being configured to change the current limit for the current associated with the power supply circuit from the peak current threshold to the cooldown threshold.

4. The power supply control circuit of claim 1, further comprising:
a comparison circuit configured to compare a current associated with the power supply circuit with the first threshold or the second threshold; and
control circuitry configured to control the power supply circuit such that the current associated with the power supply circuit does not exceed the current limit based on the comparison.

5. The power supply control circuit of claim 1, wherein the over-current condition is configured to begin when the current associated with the power supply circuit exceeds a third threshold and to end when the current decreases below a fourth threshold.

6. The power supply control circuit of claim 5, wherein the current associated with the power supply circuit comprises an input current or an output current of the power supply circuit.

7. The power supply control circuit of claim 5, wherein the fourth threshold is less than the third threshold.

8. The power supply control circuit of claim 5, wherein the fourth threshold is the same as the second threshold.

9. The power supply control circuit of claim 1, wherein:
the duty cycle measurement circuit comprises a counter configured to generate a counter signal indicating an amount of time within a configured time window that the power supply circuit is in the over-current condition; and
the multiplexer circuit is configured to set the current limit to the second threshold based on the counter signal reaching a threshold within the configured time window.

10. The power supply control circuit of claim 9, wherein the amount of time indicates an average of the duty cycle within the configured time window.

11. The power supply control circuit of claim 1, wherein, to identify the duty cycle associated with entering and exiting the over-current condition, the duty cycle measurement circuit is configured to identify duty cycles associated with entering and exiting the over-current condition within each of multiple time windows, the multiplexer circuit being configured to set the current limit based on the duty cycles.

12. The power supply control circuit of claim 11, wherein, to identify the duty cycle associated with entering and exiting the over-current condition, the duty cycle measurement circuit is configured to identify an average duty cycle across the multiple time windows, the multiplexer circuit being configured to set the current limit based on the average duty cycle.

13. The power supply control circuit of claim 12, wherein the multiplexer circuit is configured to:
set the current limit to the first threshold; and
adjust the current limit from the first threshold to the second threshold based on the average duty cycle meeting a duty cycle threshold.

14. The power supply control circuit of claim 1, further comprising a voltage divider circuit configured to generate signals representing the first threshold and the second threshold based on an input current limit (ICL) signal for the power supply circuit.

15. The power supply control circuit of claim 1, wherein the first threshold is greater than an input current limit (ICL) for the power supply circuit, and wherein the second threshold is less than the ICL.

16. A method for power supply control, comprising:
identifying, via a duty cycle measurement circuit, a duty cycle associated with entering and exiting an over-current condition; and
setting, via a multiplexer circuit, a current limit for a current associated with a power supply circuit to a first threshold or a second threshold based on the duty cycle, the second threshold being less than the first threshold.

17. The method of claim 16, wherein identifying the duty cycle includes identifying the duty cycle of a signal representing an occurrence of the over-current condition.

18. The method of claim 16, wherein:
the first threshold comprises a peak current threshold;
the second threshold comprises a cooldown threshold; and
setting the current limit comprises changing the current limit for the current associated with the power supply circuit from the peak current threshold to the cooldown threshold.

19. The method of claim 16, further comprising:
comparing, via a comparison circuit, a current associated with the power supply circuit with the first threshold or the second threshold; and
controlling, via control circuitry, the power supply circuit such that the current associated with the power supply circuit does not exceed the current limit based on the comparison.

20. The method of claim 16, wherein the over-current condition begins when the current associated with the power supply circuit exceeds a third threshold and ends when the current decreases below a fourth threshold.

21. The method of claim 20, wherein the current associated with the power supply circuit comprises an input current or an output current of the power supply circuit.

22. The method of claim 20, wherein the fourth threshold is less than the third threshold.

23. The method of claim 20, wherein the fourth threshold is the same as the second threshold.

24. The method of claim 16, further comprising generating, via a counter, a counter signal indicating an amount of time within a configured time window that the power supply circuit is in the over-current condition, the current limit being set to the second threshold based on the counter signal reaching a threshold within the configured time window.

25. The method of claim 24, wherein the amount of time indicates an average of the duty cycle within the configured time window.

26. The method of claim 16, wherein identifying the duty cycle associated with entering and exiting the over-current condition includes identifying duty cycles associated with entering and exiting the over-current condition within each of multiple time windows, the current limit being set based on the duty cycles.

27. The method of claim 26, wherein identifying the duty cycle associated with entering and exiting the over-current condition includes identifying an average duty cycle across the multiple time windows, the current limit being set based on the average duty cycle.

28. The method of claim 27, wherein setting the current limit comprises:
setting the current limit to the first threshold; and
adjusting the current limit from the first threshold to the second threshold based on the average duty cycle meeting a duty cycle threshold.

29. The method of claim 16, wherein the first threshold is greater than an input current limit for the power supply circuit, and wherein the second threshold is less than the input current limit.

30. A charger comprising:
a power supply circuit;
a duty cycle measurement circuit configured to identify a duty cycle associated with entering and exiting an over-current condition; and
a multiplexer circuit coupled to the duty cycle measurement circuit and configured to set a current limit for a current associated with the power supply circuit to a first threshold or a second threshold based on the duty cycle, the second threshold being less than the first threshold.
